(19) United States
(12) Patent Application Publication
(10) Pub. No.: US 2012/0254109 A1
(43) Pub. Date: Oct. 4, 2012

(54) DISTRIBUTED COMPONENT RUNTIME

(75) Inventors: Dharma Shukla, Sammamish, WA (US); Akash Jeevan Sagar, Redmond, WA (US); Nathan C. Talbert, Seattle, WA (US); Muthukaruppan Annamalai, Kirkland, WA (US); Robert B. Schmidt, Carlsbad, CA (US); Aditya Bhandarkar, Sammamish, WA (US); Asad Jawahar, Woodinville, WA (US)

(73) Assignee: MICROSOFT CORPORATION, Redmond, WA (US)

(21) Appl. No.: 13/073,398

(22) Filed: Mar. 28, 2011

(51) Int. Cl. G06F 17/00

(52) U.S. Cl. 707/620; 707/E17.005; 707/E17.032

(57) ABSTRACT

A method of creating a distributed application in a distributed component runtime is disclosed. An application schema including distributed modules is declaratively defined. Each module hosts a component having a corresponding logical address. Mapping the corresponding logical addresses to physical addresses at runtime virtualizes interactions between the components.

### BACKGROUND

Distributed computing applications are often deployed into environments having a multitude of different technologies and services that are used to form building blocks of the applications. Examples of distributed applications are legion and can include enterprise applications such as line of business or LOB, billing systems, customer relationship management or CRM, enterprise resource planning or ERP, business intelligence, human resource management, manufacturing, inventory control applications, and others. Such applications include components that are typically distributed across tiers in a computer network. Also, some applications are intended to run in a cloud computing environment, others are intended to run on the premises of the entity or user, and others are intended to span these environments. Further, the environment may change as an application evolves, the number of users change, or the locations of the users become dispersed.

One desirable characteristic of a distributed application is its ability to scale, or to cost-effectively change with the enterprise. Existing program models do not aim to support the development of scalable distributed applications. Typical component models are designed for desktop applications and are tier and technology specific. A distributed application is typically comprised of a set of distinct components, spread across tiers, which interact to perform work. While the components are virtualized, the relationship between the components is not. A physical wiring of components during runtime interaction is typically statically determined or otherwise hard-coded in this framework, which can place limits on the ways in which the application can be scaled or even on the application's overall ability to scale. While working with such models, many developers try to avoid writing stateful components because they are difficult to scale, but in making this choice the developer sacrifices benefits of other approaches, such as the natural expression of application logic.

Current techniques of state partitioning and replication are limited to high-end developers and are implemented by technologies of databases and distributed caches. Furthermore, current program models stich together components into composites in an ad hoc manner, which results in poorly scalable applications. There is no program model, however, that makes these techniques and technologies approachable and mainstream for developers to use in writing and scaling application state logic.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

The present disclosure is directed to a distributed composition model and runtime to virtualize the interrelationships between components in a distributed application model and to enforce and broker component interactions at runtime. The runtime enables executing composites of components in a scalable, available, and reliable manner. For example, an application schema including distributed modules is declaratively defined in a distributed environment. Each module hosts a component having a corresponding logical address. Mapping the corresponding logical addresses to physical addresses at runtime virtualizes interactions between the components. In some examples, each module is distributed on a corresponding separate physical tier, and the interactions between the components are agnostic to the corresponding physical tier. Still further, the distribution composition model and runtime provides an ability to both statically compose components at design time and dynamically compose components at runtime. Proxies are managed and procured at runtime in the distributed environment.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating an example computing device for running, hosting, or developing a distributed application.

FIG. 2 is a block diagram illustrating a distributed application programming model including a distributed component model, a distributed component runtime, and a distributed application model.

FIG. 3 is a block diagram illustrating an example schema of a distributed application according to the distributed component model of FIG. 2.

FIG. 4 is a schematic diagram illustrating a component of the distributed application of FIG. 3.

FIG. 5 is a block diagram illustrating an application definition of the distributed application of FIG. 3.

FIG. 6 is a block diagram illustrating an example application lifecycle of the distributed application of FIG. 2.

FIG. 7 is a block diagram illustrating scale out and high availability of a stateless module.

FIG. 8 is a block diagram illustrating scale out and high availability of a stateful module.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various exemplary embodiments described herein may be combined with each other, unless specifically noted otherwise.

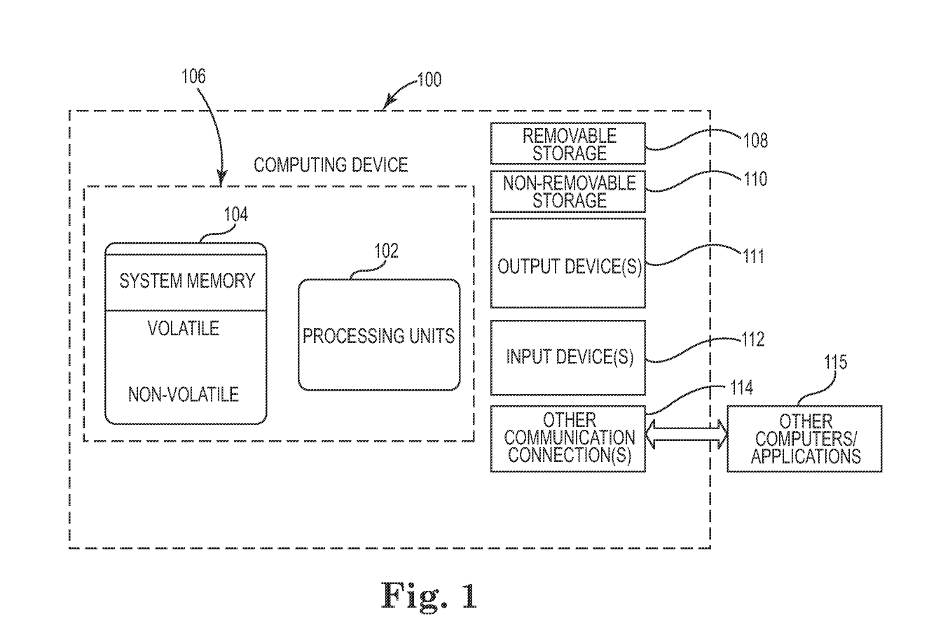

FIG. 1 illustrates an exemplary computer system that can be employed in an operating environment such as a distributed computing system or other form of computer network and used to host or run a distributed application included on one or more computer readable storage mediums storing computer executable instructions for controlling a computing device or distributed computing system to perform a method. The computer system can also be used to develop the distributed application and/or provide a serialized description or visualized rendering of the application.

The exemplary computer system includes a computing device, such as computing device 100. In a basic configuration, computing device 100 typically includes a processor system having one or more processing units, i.e., processors 102, and memory 104. Depending on the configuration and type of computing device, memory 104 may be volatile (such as random access memory (RAM)), non-volatile (such as read only memory (ROM), flash memory, etc.), or some combination of the two. This basic configuration is illustrated in FIG. 1 by dashed line 106. The computing device can take one or more of several forms. Such forms include a person computer, a server, a handheld device, a consumer electronic device (such as a video game console), or other.

Computing device 100 can also have additional features or functionality. For example, computing device 100 may also include additional storage (removable and/or non-removable) including, but not limited to, magnetic or optical disks or solid state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. An example communication connection can be an Ethernet interface. In some examples, the computing device can also have one or more additional processors or specialized processors (not shown) to perform processing functions offloaded from the processor 102. Computing device 100 may also include input device(s) 112, such as keyboard, pointing device (e.g., mouse), pen, voice input device, touch input device, etc. Computing device 100 may also include output device(s) 111, such as a display, speakers, printer, or the like.

The computing device 100 can be configured to run an operating system software program and one or more software applications, which make up a system platform. In one example, the computing device 100 includes a software component referred to as a managed, or runtime, environment. The managed environment can be included as part of the operating system or can be included later as a software download. Typically, the managed environment includes pre-coded solutions to common programming problems to aid software developers to create applications, such as software programs, to run in the managed environment. An example of a managed environment can include an application framework sold under the trade designation .NET Framework available from Microsoft, Inc. of Redmond, Wash. U.S.A.

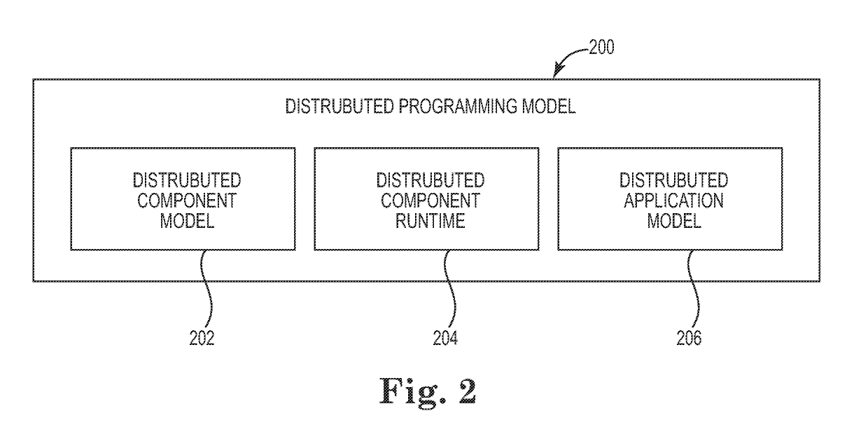

FIG. 2 illustrates a block diagram of a distributed programming model 200 that can be used to develop a distributed application on one or more computing devices 100 and/or used to deploy the distributed application on a plurality of computing devices 100 across a plurality of tiers. The programming model 200 includes a distributed component model 202, a distributed component runtime 204, and a distributed application model 206.

The distributed component model 202 includes an extensible component abstraction that is technology and tier neutral and is consistent across cloud and premise environments. The distributed component model provides support for stateless and stateful components, and provides for cloning, partitioning, and replication techniques used to scale the distributed application.

The distributed component runtime 204 includes a distributed composition engine that virtualizes the component and inter-component interactions to shield code of the distributed application from disruptions caused by scaling out the application with cloning, partitioning, and replication strategies. In one example, the composition engine is lightweight and re-hostable. The distributed composition runtime 204 brokers component interactions and also shields the distributed application from logical to physical address resolution and partition-aware routing. The distributed composition runtime 204 also standardizes the procurement and management of proxy objects used by the components to interact within the distributed application and across applications.

The distributed application model 206 provides a way to describe the distributed application components and the relationships between the components. In one example, the distributed application model 206 can include an application manifest and artifacts that can be serialized or presented in a graphic visualization within an integrated development environment, or IDE.

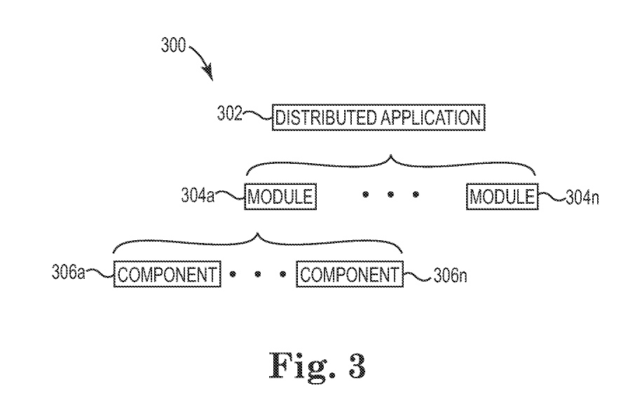

FIG. 3 illustrates a schema 300 for a distributed application 302. The schema 300 generally describes the distributed application 302 constructed according to a distributed component model in an application framework. The distributed component model 202 defines the schema 300 in abstractions including application, module, and component. The distributed application 302 includes one or more modules 304a-304n, and each module 304a-304n includes one or more components 306a-306n. Each component 306a-306n can specify imports and exports and includes metadata and artifacts. Application 302 is hosted in an application fabric that, in one example, provides the capabilities to deploy, run, and manage distributed applications that are long running, stateful, and allow high availability and elastic scale. At runtime (also referred to as execution time), the application framework provides the connections between the components 306a-306n of the application 302, described logically in the distributed component model.

The distributed application 302 has an identity and is a unit of deployment and management in the application fabric. When deployed, the application 302 spans tiers in the environment. Examples of tiers can include a client tier in many forms; a web tier, which is typically stateless, that can be available all of the time; a worker tier, including stateless and stateful components, that provides much of the logic of the application 302; and a storage tier that can be located on premises, in the cloud environment, or in a combination of the two. (Stateless can include abstractions that have no state or externalize state.) In one example, the application 302 is deployed to application fabric host farms. Physically, the application includes a package containing an application manifest that describes the compositional structure of the application, implementation details, configuration, and application artifacts. The application 302 in the example also corresponds to a tenant in the distributed component model and can include tenants of its own. This provides a layered and extensible tenant model that can be used for billing, throttling, metering, and the like.

Modules 304a-304n are a logical grouping of one or more components 306a-306n. For example, modules 304a-304n are each a tier-specific unit of hosting, which includes aspects of activation, scalability, availability, and isolation. Components 306a-306n in module 304a are deployed to the same host or single process and are typically co-located in the execution environment. The components 306a-306n often leverage the co-location for data affinity or the like.

In one example, each module is a tier-specific unit of hosting. Each module 306a-306n can have an associate role such as a worker in a worker module or web in a web module. Several types of modules can exist in the distributed component model, and the module types correspond to the capabilities of the hosting environment. Such module types can include stateless, Web, stateful, browser, and storage. A stateless module can include stateless components on modules capable of hosting stateless components, such as worker role or an application fabric role. The Web module is hosted on web hosts. A stateful module includes stateless components and can be hosted in a fabric-aware host. The browser module can be hosted in a Web browser. The storage module can be hosted on storage servers such as, for example, SQL (structured query language) database servers.

The modules 304a-304n can also include cross-cutting aspects, which include aspects and filters to lift cross cutting concerns such as logging, throttling, and metering, and the like out of the application logic. In the distributed component model, the module 304a can have zero or more cross cutting aspects associated with it. In one example, the cross cutting aspects reflect the core Aspect Oriented Programming (AOP) idioms. For example, each aspect can include zero to n advices, policy metadata, and a jointpoint for which it is being invoked. Also, each advice can include zero to n pointcuts and zero to n subscribers. The pointcut is a predicate, i.e., a LINQ expression, evaluated at a jointpoint. (Language Integrated Query (LINQ) is a component in the Microsoft .NET Framework that adds native data querying capabilities to .NET languages, such as C-sharp (C#)). Upon pointcut evaluation, all Before, After, and Around advices are invoked.

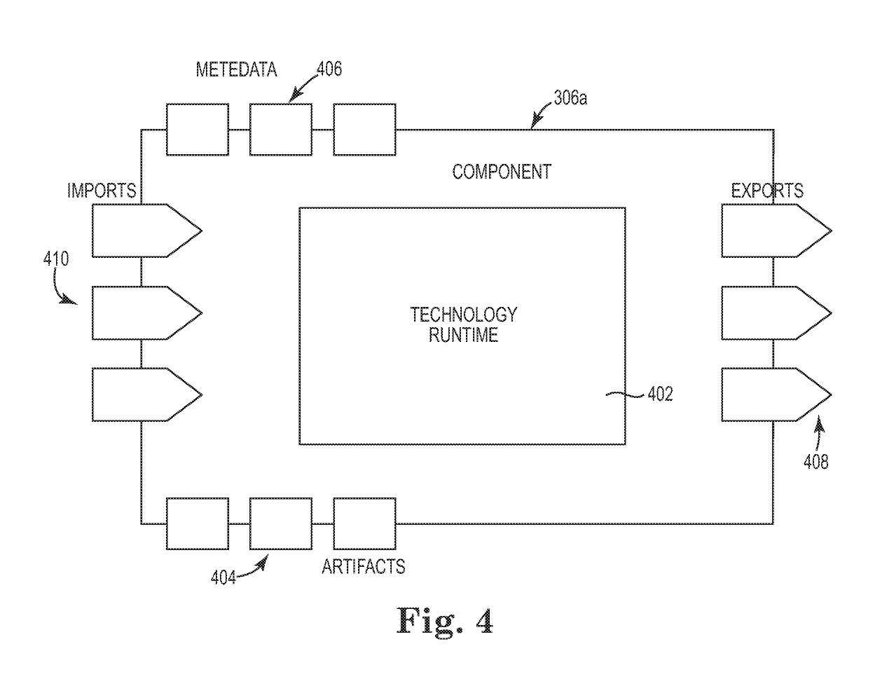

FIG. 4 illustrates a component, such as component 306a. In the distributed component model 202, a component is a unit of technology encapsulation, extensibility, composition, and reuse. The component 306a includes a technology 402, artifacts 404, metadata 406, exports 408, and imports 410 described below. (Components 306a-306n are distinguishable from a common language runtime object/type or with components in other technologies like component object model or distributed component object model, i.e., “COM/DCOM.”)

The component 306a encapsulates a certain technology 402. Such technologies can include, for example, web application technologies or application programming interfaces for building connected, service-oriented applications. More than one component type can be developed for a given technology. For example, the application 302 could include a web application component and a service component in the web tier, a code component, a cache component, and a workflow component in the worker tier, and various storage components (such as tables or queues) and an SQL database component in the storage tier. In one example, the component 306a is a wrapper 412 around a set of functionality. This wrapper 412 hides the implementation details of the component yet exposes the functionality and dependencies that can allow loose coupling between service provider and consumers.

The component 306a can include artifacts 404 and define the metadata 406 at runtime. In one example, a component metadata 406 can include a security configuration. A component artifact 404 can include configuration files, binaries, user code, and the like. Component metadata 406 and artifacts 404 can be captured in the application manifest and are made available to the component at runtime.

Components 306a-306n can export, i.e., offer, a set of capabilities and can import, i.e., use, a set of capabilities. A component can export a capability or a service that can be consumed by other components. Also, a component can import a capability or a service for consumption from another component 306n in the application 302 or from an external service. Thus, component exports 408 and component imports 410 are the mechanisms by which the components 306a-306n are stitched together to form the application 302. Stitching may be described at the design stage or can be dynamic in that available exports can be discovered, imported, and used at runtime. In either case, the stitching is a logical expression of a component relationship. The procurement of proxies and the resolution of physical addresses to get two component instances communicating are brokered at runtime.

The component export 408 is a declarative specification of a capability offered at runtime. The component export 408 can also represent an external piece of the application that is not part of the application being modeled. For example, an export 408 can represent a message queuing technology such as one offered under the trade designation of MSMQ available from Microsoft, Inc. or a web service such as one offered under the trade designation of Amazon Web Services (AWS) available from Amazon.com of Seattle, Wash. U.S.A. The component export 408 also includes runtime logic to manufacture proxies that component imports can use. Component exports 408 can be made visible at different scopes such as within the application or externally. Similar to components 306a-306n, component exports 408 are associated with metadata and artifacts. Within the application 302, an export 408 can be identified by a contract and a logical address. The shape and semantics of the contract can be related to the technology 402 used and is opaque to the distributed component model. In one example, component exports 408 are reusable, and independent software vendors can provide the components exports 408 as a library. The component export includes metadata regarding cardinality, which specifies the number of imports acceptable to the component: none, one, or more than one.

A component import 410 is also a declarative specification of a capability consumed by an instance of the component 306a. Component imports 410 are satisfied by component exports from other components that match the criteria of the component import 410, and the matching criteria is expressed as a declarative predicate on the component import 410. The predicate is evaluated to match/select from a set of available component exports visible scope of the component requesting the import. In one example, the component 306a will determine a match based on the name of the predicate, but the component can also determine a match on import/export metadata specified by an author of the component 306a or the application 302. The component import 408 typically includes metadata regarding to cardinality, which specifies the number of exports acceptable to the component 206a: none, one, or more than one.

The distributed component model 202 provides a mechanism for declaratively describing and constructing the distributed application 302 in an application definition. The application definition describes a form of a type system that captures the components 306a-306n within the application 302, the producer-consumer relationships between the components 306a-306n, and any external components or services consumed by components 306a-306n in the application 302. The application definition describes the configuration and constraints of the components as well as component dependencies, interrelationships, and interactions of the distributed application in a declarative manner. The application definition also provides the ability to schematize and extend the compositional structure and metadata, such as metadata 406, in a format/representation agonistic manner. It can be use to validate the compositional structure of the distributed application 302 as well as enforce the composition structure at runtime. Such a representation of compositional structure of an application having complex interactions among a set of distributed components provides the ability to reason over an application lifecycle and can be used to scale the distributed application 302 in a distributed environment.

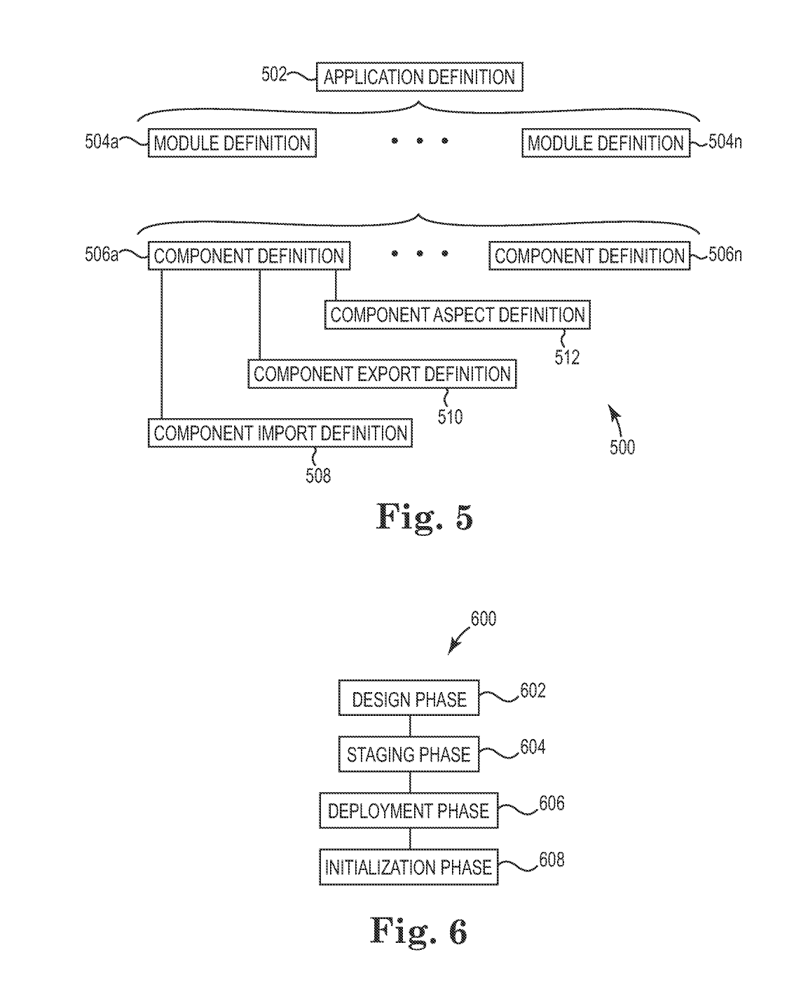

FIG. 5 illustrates an example application definition 500. The application definition 500 includes the constructs of an application definition 502, one or more module definitions 504a-504n, and one or more component definitions 506a-506n for each module definition 504a. The arrangement of the definition constructs resembles an ontology similar to the distributed application schema 300 as a definition tree. The root of the definition tree is the application definition 502. Each of the module definitions 504a-504n corresponds with a particular module of the module 304a-304n. Each component definition 506a-506n corresponds to one of the components of components 306a-306n. Additional constructs are included in the definition tree depending on the particular features of the components. For example, each component using an import includes a component import definition 508, and each component offering an export includes a component export definition 510. Each component that provides an aspect, such as a cross-cutting concern, includes a component aspect definition 512.

The definition constructs include a declarative description of the corresponding application, module, and component. Each definition construct includes associated metadata that further describes the construct. In one example, the component definitions 506a-506n for the application each include a common set of metadata that describe the fundamental aspects of the corresponding component. Similarly, the module definitions 504a-504n for the application each include a common set of metadata that describe the fundamental aspects of the corresponding module. The component import definitions 508, the component export definitions 510, and the component aspect definitions 512 can each include common sets of metadata. In addition to the common set of metadata, each component definition can specify component-specific metadata, which is also true for module, component export, component import, and component aspect definitions. In one example, the component-specific metadata is opaque to the distributed component model and is understood by the component 206a and other components that consume it. The application definition 500 in the distributed component model is validated to enforce component interrelationship and metadata. Each definition construct can also specify custom validation logic against the application definition.

FIG. 6 illustrates how the application definition 300 is created and is used through an application lifecycle 600. The distributed application 302 is constructed during the application design phase at 602. The distributed application 302 is constructed as per the schema 300 prescribed by the distributed component model. The output of the design phase 602 is a serialized application package that contains the application manifest and the artifacts that make up the different components 306a-306n. The application package is staged in an application fabric repository during an application staging phase at 604. The application package is posted to an end point on which an application farm fabric manager is listening. Once the distributed application 302 is posted, the application fabric farm manager shreds the application package. The application farm manager will access the artifacts for each component 306a-306n according to the application manifest and stores them in the application fabric repository. The application farm manager will also expose the application hierarchy as a Representative State Transfer (REST) resource that can be accessed by other applications or by the component code themselves. The distributed application 302 stored in the application fabric repository is deployed to a host farm during the deployment phase at 606. In order to deploy the distributed application 302 to the host farm, the farm manager will look at the application manifest and deploy the appropriate modules 304a-304n within the application to a corresponding set of nodes within the host farm. During an application initialization phase at 608, the various different modules 304a-304n deployed to the nodes are loaded into the host process and the components 306a-306n within the modules 304a-304n start executing. If the component is a service, the component will create the end point and start listening on the end point.

The distributed programming model 200 provides developers and enterprises the ability to cost-effectively build, run, and evolve the distributed application 302. Both stateful and stateless components can be developed using familiar technologies, emerging technologies, and custom paradigms for specific domains. The components 306a-306n can be stitched together either statically or dynamically to form the application 302. Cloning, replication, and partitioning are supported within the application 302, as is the ability to make architectural tradeoffs such as among consistency, availability, and tolerance of “partitions” (such as describe in Brewster's CAP Conjecture).

The distributed programming model 200 provides for scalable applications to include the techniques of cloning, replication, and partitioning. Different techniques may apply to different parts of the application 302, which may change over time as the application grows. For example, cloning is a relatively straightforward technique, but in certain technologies it is exclusively suited for stateless components. Replication is currently an effective technique for stateful components, but it can be complex and limited. For example, the amount of state can grow during the life of the application 302 such as in the form of user sessions or cached data that are replicated across machines, or a row-locking scheme in a shared store that becomes the bottleneck to the performance of the application 302. In order to address the issue of growing state, a developer may choose to partition one or more components, which previously involved a costly and difficult re-architecture of the application 302.

In order to avoid a costly re-architecture, the application 302 is initially designed in a distributed component model 202 to support partitioning, which can be used regardless of whether application growth is anticipated. Design patterns and use of a distributed component runtime 204 can make intra-component wiring immune to otherwise invasive changes such as sharding, which is typically know as horizontal partitioning of a database, and component partitioning. Partitioning is made available in the application 302 and then is activated as desired. The application 302 can be readily designed to map the partitions to machines as well. Additionally, the developer can retain flexibility about whether a component 306a or the entire application 302 runs on premise or in a cloud computing environment. As the costs of infrastructure change over time, the architecture of the application 302 can naturally evolve to take advantage of the relative cost changes.

Each module 304a can be a logical grouping of related components 306a-306n for the purposes of co-location and partitioning. Components 306a-306b grouped together within a module can run within the same application domain. For example, two or more components 306a-306n can be co-located if they abide by the same partitioning scheme. In a partitioned module, each part is independent of the others and hence receives its own application domain within which the set of co-partitioned components for the corresponding part will run. The components 306a-306n within a module, such as module 304a, can communicate via direct method invocations. Across modules 304a-304n, components communicate by sending messages. A module type can correspond to the capability of the host. For example, a stateless component, such as a web role, is hosted in a stateless module. Execution environments for modules include web and worker roles for stateless components and a fabric role for stateful components.

During runtime, the distributed programming model 200 can monitor the application 302 to diagnose and repair issues as well as meter the use of the components 306a-306n. The distributed component model 202 can elastically allocate and reclaim resources to support a fluctuating demand. Further, the distributed programming model 200 provides for the ability to later partition the application 302, co-locate partitioned components 306a-306n, change a mapping of partitions to a physical infrastructure, and shard a database without costly re-architecture.

In distributed applications created using the distributed component model 202, the distributed component runtime 204 is used to broker component interactions. Interactions between components in the distributed application 302 are virtualized with logical addresses that are mapped to physical addresses with the distributed component runtime 204. The distributed component runtime 204 arbitrates the procurement of physical addresses from the hosting environment, maintains a logical to physical address mapping, and performs the logical to physical translation at runtime. Composition of components is agnostic of the locality of the importing and exporting components. In the distributed component model 202, an importing component does not know the physical address of the exporting component. The distributed component runtime 204 provides the logical to physical translation of addresses at application runtime when these interactions materialize. Logical addresses are assigned to component exports and are used to reference components in the application 302. Distributed component runtime 204 also addresses and routes to the appropriate partition.

A component 306a may have several exports 408 and thus have a set of logical and physical addresses. For example, the component includes one logical address per export 408 and one physical address per runtime instance of each export. Each component export 408 has a logical address that can be used to identify the component export 408 as a single logical entity. The distributed component runtime 204 assigns each export a logical address that is stable and safe for caching. At runtime, each runtime copy of the component can register a physical address.

Physical addresses typically are not stable and thus typically not safe for caching. Components that create a listener will obtain or register a physical address for the listener from the distributed component runtime 204. A component export may have different requirements around the protocol or listening technology that impact the physical listen address. These requirements are passed to the distributed component runtime as a listen address hint, specified in the component definition, which is used to request or claim an appropriate listen address in the hosting environment.

Composition of components in the distributed application 302 can be static or dynamic. In static composition, the relationships between importing and exporting components are established statically and at design time. Static composition is a degenerate case of the more general dynamic composition. In static composition, the importing component includes an import predicate that is set to a known value. The known value does not change at runtime and thus it is possible to determine the matching exporting components statically at design time. This type of composition lends itself to a complete static analysis of the composite application. In dynamic composition, the relationships between importing and exporting components are established dynamically and at run time. Matching of components is established by the distribute composition runtime 204 and includes evaluating import predicates against available exports within the scope or visibility of the importing component.

The distributed component runtime 204 arbitrates the procurement and lifetime management of proxies to exports. For example, an importing component can request a proxy to one of its imports. The distributed component runtime 204 provides a configured proxy with the resolved physical address of the corresponding export. The importing component can directly use the proxy to interact with the exporting component. The importing component can specify a lifetime policy for the proxy object such as singleton or per call. This policy is propagated by the distributed component runtime 204 when the proxy object is created and is honored by the proxy generation logic.

The distributed component runtime 204 can provide cross cutting services to all executing components in terms of aspects such as logging, tracing, monitoring, throttling, metering. The goal of aspects is to lift cross cutting concerns out of application logic. Aspects also can be associated at the module 304a-304b and the application 302 levels. At runtime, the distributed component runtime weaves these aspects. The distributed component runtime 204 provides joinpoints on calls that enter component code such as with lifecycle changes. The distributed component runtime 204 also invokes the appropriate advice of the aspect (before, after, around) after filtering by evaluating pointcut expressions specified by the aspect. Each aspect implementation calls out to the hosting environment via a defined provider interface.

In one example, an application fabric available under the trade designation of AppFabric can run on premise, such as a server operating system available under the trade designation of Windows Server, and in a cloud environment having a cloud computing or cloud services operating system available under the trade designation Windows Azure, all available from Microsoft, Inc., allowing entire applications (or components within them) to be deployed to either environment or a combination the two. Web roles, workflow, and the like can be built using developer tools such as those sold under the trade designations of Windows Communication Foundation (WCF) and Windows Workflow Foundation (WF) available from Microsoft, Inc.

In one example, a distributed application manifest provides the distributed application model 206 in definition constructs expressing the component configurations and their interrelationships to each other and interactions in a technology and format agnostic manner. The manifest is a serialized form of the application definition 500 and captures the entire structure of the application 302. In one example, the manifest is format agnostic and can be serialized in a variety of formats, which can include scripting languages such as extensible markup language (XML), extensible application markup language (XAML), JavaScript object notation (JSON), or binary JSON (BSON) and many others now know or yet to be created. The following example distributed application manifest is serialized in JSON:

{
“Name”: “MyApp”,
“Id”: “622BN4TFQB3UHFEERJGFXPVX4A”,
“BaseUri”: http://MyApp.cloudapp.net/,
“SelfLink”: “...”,
“Version”: “1.0.0.100”,
“References”: [

{“Type”: “DistributedList”,...}, {“Type”:“TaskScheduler”,...}, {“Type”:“CloudQueue”,...},

{“Type”: “WCFService”,...} ],

“ModuleDefinitions”:
[

{“Name”: “MyWebModule”, Type” : “Web”, “InstanceCountHint”: 2, “Components”: [ {...}] },
{“Name”: “MidTierModule”, “Type” : “Stateful”, “InstanceCountHint”: 2,
“IsolationLevel”: “Process”, “MachineSize”: “Large”,
“PartitionPolicy”: { “Type”: “RangePartitionPolicy”, “Keys”: [ “A-G”, “H-M”,“N-Z”] },

“ReplicaCountHint”: 2, “ReplicationFormat”: “JSON”, “WriteQuorum”: 1,
“Components”:
[

{“Name”: “MovieProcessor”, “ModuleAffinity”: “Stateful”, ...

“Imports”:
[

{“Name”: “DistributedList”, “Cardinality”: “ExactlyOne”, “InstancingPolicy”:

“Pooled”, “Constraint”: {...} } },

{“Name”: “NewMovies”,“Cardinality”: “AtleastOne”,“InstancingPolicy”:

“Singleton”,“Constraint”: {...} } },

{“Name”: “MovieService”,“Cardinality”: “AtleastOne”,“InstancingPolicy”:

“Singleton”,“Constraint”: {...} } },

{“Name”: “TaskScheduler”,“Cardinality”: “AtleastOne”,“InstancingPolicy”:

“Singleton”,“Constraint”: {...} } },

],

}

]

}

```
  ...
  ]
  ...
}
```

The manifest includes the application definition 502, the module definitions 504a-504n, component definitions 506a-506n, component exports 508, component imports 510, and component aspects 512. In the example, the module definitions 504a-504n include metadata on instances, partitions, and replicas. A stateless module definition can include a declaratively defined instance count that control the number of module instances and describes the scalability and high availability (often referred to as “HA”) characteristics of a stateless module and its corresponding components. A stateful module definition can include a declaratively defined instance count, a partition policy, and a replica count to describe the scalability and high availability characteristics of a stateful module and its corresponding components. In order to evolve or scale the application, a developer adjusts the counts and policies within the metadata of the module definition to a selected amount.

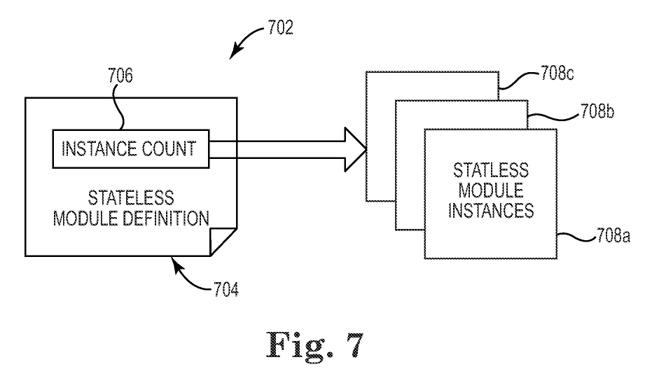

FIG. 7 illustrates scale out and high availability of a stateless module 702, which can correspond with module 304a for this example. The corresponding module definition 704 of the stateless module 702 includes an instance count 706 in the metadata. The instance count 706 controls the number of module instances, i.e., the scale out and high availability characteristics of the stateless module 702. The example module definition 704 includes an instance count 706 of “3,” and thus three instances of the stateless module, i.e., instances 708a, 708b, 708c, are created at runtime. For example, the module definition 704 can include metadata regarding “Enable High Availability,” which indicates if the module should be made highly available. Additionally, the module definition can include metadata regarding “Instance Count Hint,” which specifies the number of instances of the stateless modules 708a-708n to create at runtime.

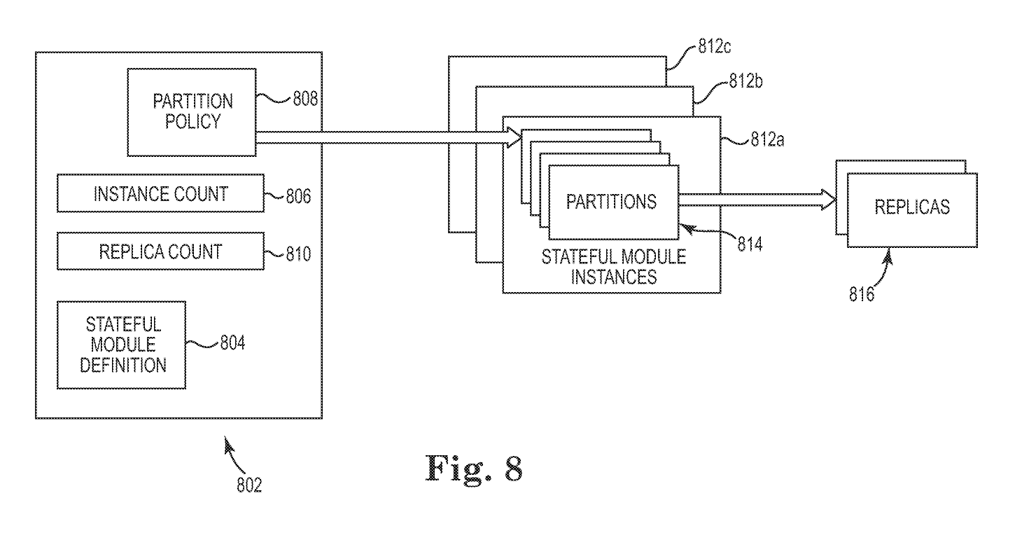

FIG. 8 illustrates scale out and high availability of a stateful module 802, which can correspond with module 304n for this example. The corresponding module definition 804 of the stateful module 802 includes an instance count 806, a partition policy 808, and a replica count 810 in the metadata. The instance count 806 controls the number of module instances and thus scale out. The partition policy 808 controls the number of partitions assigned to a given module instance. The replica count 810 controls the high availability and determines the number of replicas 816 to each partition. The example module definition 804 includes an instance count 806 of “3”, i.e., instances 812a, 812b, 812c. The example partition policy 808 assigns four partitions 814 to each instance 812a, 812b, 812c, and the example replica count assigns two replicas 816 to each partition. The instances 812a, 812b, 812c, partitions 814, and replicas 816 are created at runtime.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of creating a distributed application in a distributed component runtime, comprising:
declaratively defining an application schema including a plurality of distributed modules wherein each module hosts a component having a corresponding logical address; and
virtualizing interactions between the components by mapping the corresponding logical addresses to physical addresses at runtime.

2. The method of claim 1 wherein each module includes a logical grouping of a plurality of components.

3. The method of claim 1 wherein the components include component exports and component inputs, and wherein the components are stitched together by the component imports and exports.

4. The method of claim 3 wherein the components that are stitched together are agnostic of locality of the components.

5. The method of claim 3 wherein each component export is identified by a contract and a logical address.

6. The method of claim 3 wherein the component import of one of the components and the component export of a another component are stitched together if the component import and the component export satisfy a matching criteria.

7. The method of claim 6 wherein matching criteria are expressed as a declarative predicate on the component import.

8. The method of claim 3 wherein the components are statically stitched together.

9. The method of claim 8 wherein relationships between components are determined at design time.

10. The method of claim 3 wherein the components are dynamically stitched together.

11. The method of claim 19 wherein relationships between components are determined at runtime.

12. The method of claim 1 wherein the components include stateless components that are cloned at runtime.

13. The method of claim 1 wherein the components include stateful components that support partitioning.

14. The method of claim 13 wherein the stateful components include a partitioning scheme.

15. The method of claim 14 wherein two stateful components that abide by the same partitioning scheme are co-located in one of the plurality of modules.

16. The method of claim 1 and further comprising managing and procuring proxies at runtime.

17. A computer readable storage medium storing computer executable instructions for controlling a computing device to perform a method comprising:
creating a distributed application in a distributed component runtime, the creating comprising:
declaratively defining an application schema including a plurality of distributed modules wherein each module hosts a component having a corresponding logical address, and each module is distributed on a corresponding separate physical tier; and
virtualizing interactions between the components by mapping the corresponding logical addresses to physical addresses at runtime wherein the interactions between the components are agnostic to the corresponding physical tier;
wherein the interactions between the components are dynamically composed at runtime.

18. The computer readable storage medium of claim 17 wherein each module includes a plurality of components, wherein communications between components within a module is via direct method invocations and communications between components in separate modules is via sending messages.

19. The computer readable storage medium of claim 17 and further including monitoring and repairing components interactions, and metering component use.

20. A method of creating a distributed application in a distributed component runtime, comprising:
declaratively defining an application schema including a plurality of distributed modules wherein each module hosts a component having a corresponding logical address, and each module is distributed on a corresponding separate physical tier in a distributed environment;
virtualizing interactions between the components by mapping the corresponding logical addresses to physical addresses at runtime wherein the interactions between the components are agnostic to the corresponding physical tier;
wherein the virtualizing interactions between components includes an ability to both statically compose components at design time and dynamically compose components at runtime; and
managing and procuring proxies in the distributed environment at runtime.
